(19) United States
(12) Patent Application Publication
(10) Pub. No.: US 2008/0049164 A1
(43) Pub. Date: Feb. 28, 2008

(54) BACKLIGHT ASSEMBLY, MANUFACTURING METHOD THEREOF, AND LIQUID CRYSTAL DISPLAY DEVICE

(75) Inventors: Eun-chae JEON, Seoul (KR); Si-joon SONG, Yongin-si (KR); Eun-jeong KANG, Cheonan-si (KR); Gi-cherl KIM, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD.,, Suwon-si (KR)

(21) Appl. No.: 11/842,249

(22) Filed: Aug. 21, 2007

(30) Foreign Application Priority Data
Aug. 22, 2006 (KR) 1020060079080
Dec. 1, 2006 (KR) 1020060120606

(51) Int. Cl. G02F 1/1335; F21V 7/04; H01J 9/24

(52) U.S. Cl. 349/61; 362/623; 362/631; 445/24

(57) ABSTRACT

A backlight assembly includes a plurality of point light source substrates each including a substrate main body, a power supplying line disposed on the substrate main body, and a pad part disposed on the substrate main body and electrically connected to the power supplying line, a point light source disposed on each of the point light source substrates and supplied with power through the power supplying line, and a connecting film connecting adjacent point light source substrates and including a first film main body and a metal pattern disposed on the first film main body and electrically connected with the pad part.

This application claims priority to Korean Patent Application No. 2006-0079080, filed on Aug. 22, 2006, and Korean Patent Application No. 2006-0120606, filed on Dec. 1, 2006, and all the benefits accruing therefrom under 35 U.S.C. §, the contents of which are incorporated herein by reference in their entireties.

### BACKGROUND OF INVENTION

1. Field of Invention

A backlight assembly, a manufacturing method thereof and a liquid crystal display device provided the present invention relate to connection of a plurality of point light source substrates.

2. Description of the Related Art

A liquid crystal display device includes a liquid crystal display panel and a backlight assembly. The liquid crystal display panel includes a first substrate, a facing substrate, and a liquid crystal layer positioned between both substrates. The liquid crystal display panel is supplied with light from the backlight assembly positioned behind the first substrate. Transmittance of light emitted from the backlight assembly is adjusted according to arrangement of a liquid crystal.

For a light source of the backlight assembly, a point light source such as a light emitting diode is gaining in popularity instead of a line light source such as a lamp. The point light source is mounted on a point light source substrate.

As a screen size of the liquid crystal display device becomes enlarged, a plurality of point light source substrates have been used. Since the point light source substrates are electrically connected by a connector and a cable, a configuration of the backlight assembly becomes complicated due to the relatively large number of the connectors and the cables required.

### BRIEF SUMMARY OF THE INVENTION

An exemplary embodiment provides a backlight assembly electrically connecting a plurality of point light source substrates in a simple configuration.

An exemplary embodiment provides a manufacturing method of a backlight assembly electrically connecting a plurality of point light source substrates in a simple method.

An exemplary embodiment provides a liquid crystal display device including a backlight assembly electrically connecting a plurality of point light source substrates in a simple configuration.

An exemplary embodiment provides a backlight assembly including a plurality of point light source substrates each including a substrate main body, a power supplying line disposed on the substrate main body, and a pad part disposed on the substrate main body and electrically connected to the power supplying line, a point light source disposed on each of the point light source substrates and supplied with power through the power supplying line, and a connecting film connecting adjacent point light source substrates and including a first film main body and a metal pattern disposed on the first film main body and electrically connected with the pad part.

In an exemplary embodiment, the point light source includes a light emitting diode.

In an exemplary embodiment, the point light source includes a chip, and the chip is disposed on the point light source substrates as a chip on board (“COB”) type.

In an exemplary embodiment, the metal pattern includes a plurality of metal patterns, and the plurality of metal patterns are disposed parallel with each other.

In an exemplary embodiment, the metal pattern includes copper.

In an exemplary embodiment, the first film main body includes a plastic material, and the connecting film is configured to be flexible.

In an exemplary embodiment, the backlight assembly further includes a reflecting sheet including a through hole exposing the point light source and disposed over the point light source substrates. The connecting film is contacted with the reflecting sheet.

In an exemplary embodiment, the connecting film further includes a second film main body, and the metal pattern is disposed between the first film main body and the second film main body.

In an exemplary embodiment, an end portion of the metal pattern is exposed out of at least one of the first film main body and the second film main body.

In an exemplary embodiment, the first film main body includes acryl glass.

In an exemplary embodiment, the backlight assembly further includes an anisotropic conductive film disposed between the metal pattern and the pad part.

In an exemplary embodiment, the backlight assembly further includes a solder disposed between the metal pattern and the pad part.

In an exemplary embodiment, the pad part and the point light source are disposed on a same surface of the point light source substrates.

In an exemplary embodiment, the backlight assembly further includes a reflecting sheet including a through hole exposing the point light source and disposed over the point light source substrates. The reflecting sheet covers the connecting film.

In an exemplary embodiment, the backlight assembly further includes a reflecting sheet includes a through hole exposing the point light source and the connecting film and disposed over the point light source substrates. Exposed surface of the connecting film include a reflecting particle.

In an exemplary embodiment, the pad part and the point light source are disposed on opposing sides of the point light source substrates.

In an exemplary embodiment, the point light source substrates are disposed to have a matrix shape.

An exemplary embodiment provides a manufacturing method of a backlight assembly. The method includes providing a first point light source substrate and a second point light source substrate, each of the first and second point light source substrates including a substrate main body and a pad part disposed on the substrate main body, providing a connecting film including a film main body and a metal pattern disposed on the film main body, mounting a point light source to each point light source substrate, the point light source configured to be supplied with power through the pad part, and connecting a first end part of the metal pattern to the pad part of the first point light source substrate, and connecting a second end part of the metal pattern to the pad part of the second point light source substrate.

An exemplary embodiment provides a liquid crystal display device including a liquid crystal display panel, and a backlight assembly which is positioned in rear of the liquid crystal display panel to supply light to the liquid crystal display panel. The backlight assembly includes a plurality of point light source substrates including a substrate main body, a power supplying line disposed on the substrate main body, and a pad part disposed on the substrate main body and electrically connected to the power supplying line, a point light source disposed on the point light source substrates and supplied with power through the power supplying line, and a connecting film including a first film main body and a metal pattern disposed on the first film main body and electrically connected with the pad part. The connecting film connects the point light source substrates which are adjacent to each other.

In an exemplary embodiment, the point light source includes a light emitting diode.

In an exemplary embodiment, the point light source includes a chip, and the chip is mounted to the point light source substrates in a chip on board (“COB”) type.

In an exemplary embodiment, the metal pattern includes a plurality of metal patterns extending parallel to each other.

In an exemplary embodiment, the metal pattern includes copper.

In an exemplary embodiment, the first film main body of the connecting film includes a plastic material, and the connecting film is flexible.

In an exemplary embodiment, the connecting film further includes a second film main body, and the metal pattern is disposed between the first film main body and the second film main body.

In an exemplary embodiment, an end portion of the metal pattern is exposed out of at least one of the first film main body and the second film main body.

In an exemplary embodiment, the first film main body includes acryl glass.

In an exemplary embodiment, the liquid crystal display device further includes a solder disposed between the metal pattern and the pad part.

### BRIEF DESCRIPTION OF THE DRAWINGS

The above and/or other aspects of the prevent invention will become apparent and more readily appreciated from the following description of the exemplary embodiments, taken in conjunction with the accompanying drawings, in which:

FIG. 1 is an exploded perspective view of an exemplary embodiment of a liquid crystal display device according to the present invention;

FIG. 2 is an exploded perspective view of an exemplary embodiment of a main part of a backlight assembly of a liquid crystal display device according to the present invention;

FIG. 3 illustrates an exemplary embodiment of a light emitting diode of a liquid crystal display device according to the present invention;

FIG. 4 is a perspective view of an exemplary embodiment of a connecting film of a liquid crystal display device according to the present invention;

FIG. 5 is an exemplary embodiment of a cross-sectional view of a main part of a liquid crystal display device according to the present invention;

FIGS. 6 to 8 are other exemplary embodiments of cross-sectional views of main parts of a liquid crystal display device according to the present invention;

FIG. 9 illustrates another exemplary embodiment of a light emitting diode of a liquid crystal display device according to the present invention;

FIG. 10 is a perspective view of another exemplary embodiment of a connecting film of a liquid crystal display device according to the present invention;

FIG. 11 is a cross-sectional view of an exemplary embodiment of a connecting film of a liquid crystal display device according to the present invention;

FIG. 12 is a perspective view of another exemplary embodiment of a connecting film of a liquid crystal display device according to the present invention; and

FIG. 13 is a cross-sectional view of another exemplary embodiment of a main part of a liquid crystal display device according to the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

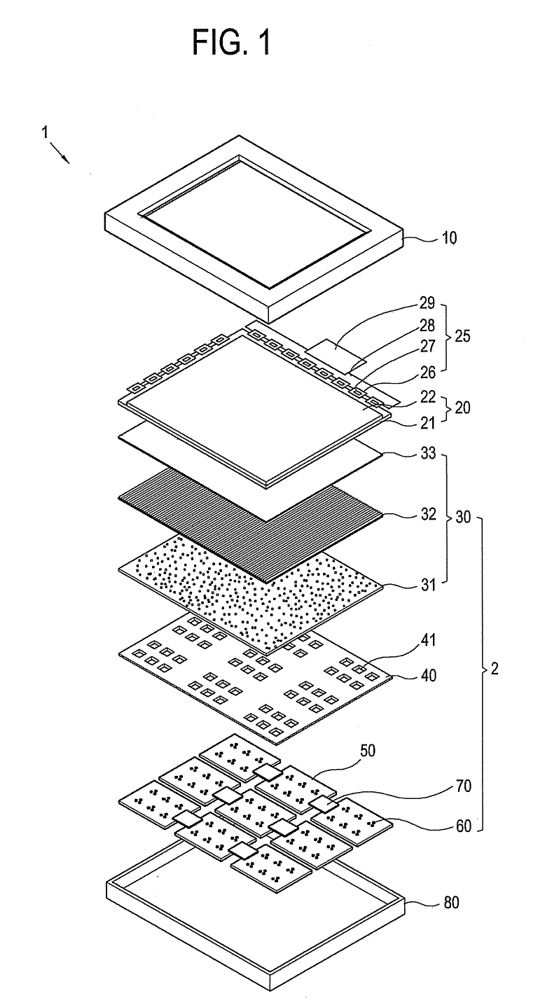

FIGS. 1 to 5 illustrate exemplary embodiments of a liquid crystal display device 1 according to the present invention. As shown therein, an electric connection of light emitting diode substrates 50 is illustrated. A power supplying part (not shown) may be connected between the light emitting diode substrates 50. In an exemplary embodiment, the power supplying part may be provided to an outer surface of a lower cover 80 and/or the power supplying part and the light emitting diode substrate 50 may be electrically connected through a connecting film 70.

As shown in FIG. 1, the liquid crystal display device 1 includes a liquid crystal display panel 20, and a backlight assembly 2 supplying light to the liquid crystal display panel 20. The liquid crystal display panel 20 and the backlight assembly 2 are accommodated within (e.g., between) an upper cover 10 and the lower cover 80, such as in a receiving space defined by the upper cover 10 and the lower cover 80. As in the illustrated embodiment, the backlight assembly 2 includes a light adjusting member 30, a reflecting sheet 40, a light source substrate 50 (hereinafter referred to as the light emitting diode substrate), a light source 60, such as a light emitting diode (“LED”) and the connecting film 70.

The liquid crystal display panel 20 includes a first substrate 21, such as formed with a thin film transistor, and a second substrate 22 facing the first substrate 21. A liquid crystal layer (not shown) is positioned between both substrates 21 and 22. The liquid crystal display panel 20 adjusts an arrangement of the liquid crystal layer to display images. The liquid crystal display panel 20 is a non-light emitting element and is supplied with light from the backlight assembly 2 positioned behind the liquid crystal display panel (e.g., under or adjacent to a lower surface of the liquid crystal display panel 20).

A driving part 25 is provided to a side of the first substrate 21 to supply a driving signal, such as at a longitudinal edge of the first substrate 21. The driving part includes a flexible printed circuit (“FPC”) substrate 26, a first side of which is connected to the first substrate 21 of the liquid crystal display panel 20, a driving chip 27 mounted to the flexible printed circuit substrate 26, a connecting circuit substrate 28 connected to a second side of the flexible printed circuit substrate 26, and a driving circuit substrate 29 connected to the connecting circuit substrate 28. In an exemplary embodiment, the driving part 25 may employ a chip on film (“COF”) structure. Alternatively, the driving part 25 may employ a tape carrier package (“TCP”), a chip on glass (“COG”) or other known configurations. In an exemplary embodiment, a part of the driving part 25 may be formed to the first substrate 21, such as using a line forming process.

The light adjusting member 30 positioned to a rear of the liquid crystal display panel 20 may include a plurality of optical sheets. The optical sheets may include, but are note limited to, a diffusing member or plate 31, a prism member or film 32 and a protecting member or film 33.

The diffusing plate 31 may include a base plate, and a coating layer. In an exemplary embodiment the coating layer may include a bead formed on or attached to the base plate. The diffusing plate 31 is configured to diffuse light supplied from the light emitting diode 60 such as to make a brightness of light substantially uniform.

The prism film 32 may be include triangular prisms substantially uniformly arranged on an upper surface of the prism film 32. The prism film 32 is configured to collect light diffused through the diffusing plate 31 in a substantially perpendicular direction with respect to a plane of the liquid crystal display panel 20 positioned above the optical sheets.

In an exemplary embodiment, the prism film 32 may be provided in a pair, and/or micro prisms may be formed to each prism film 32 and having a predetermined angle. Most of light passing through the prism film 32 perpendicularly advances to supply a uniform brightness distribution to the liquid crystal display. Alternatively, a reflecting polarizing film (not shown) may be provided together with the prism film 32 as is suitable for the purpose described herein. Alternatively, only reflecting polarizing film may be used without the prism film 32 as is suitable for the purpose described herein.

The protecting film 33 positioned uppermost relative to the other parts of the light adjusting member 30 is configured to protect the prism film 32 which may be liable to be scratched.

In an alternative exemplary embodiments, the light adjusting part 30 may further include a reflecting polarizing film (not shown).

In an alternative exemplary embodiment, the backlight assembly 2 may further include a spacer (not shown) disposed and configured to maintain an interval between the reflecting sheet 40 and the diffusing plate 31.

The reflecting sheet 40 is disposed on the light emitting diode substrate 50. Portions of the reflecting sheet 40 are positioned on the light emitting diode substrate 50 such as where the light emitting diode 60 is not mounted on the light emitting diode substrate 50. The reflecting sheet 40 includes a through hole 41 corresponding to an arrangement of the light emitting diode 60. As in the illustrated embodiment, each light emitting diode 60 is exposed through the through hole 41. As used herein, “corresponding” is used to indicate corresponding substantially in shape, dimension and/or positional placement.

The reflecting plate 40 reflects light incident from below to be supplied to the diffusing plate 31 of the light adjusting member 30. In exemplary embodiments, the reflecting plate 4Q may be formed of polyethylene terephthalate (“PET”), or poly carbonate (“PC”), and/or may be laminated with silver or aluminum. The reflecting plate 40 may have such a thickness so as not to be wrinkled or deformed by a relative strong heat generated from the light emitting diode 60.

The light emitting diode substrate 50 has a substantially rectangular shape. As in the illustrated embodiment, nine light emitting diode substrates 50 are arranged in a matrix form of three by three light emitting diode substrates 50. However, the present invention is not limited thereto. In exemplary embodiments, any of a number of light emitting diode substrates 50 may be used as is suitable for the purposes described hereafter.

The light emitting diode substrate 50 is provided not singly but in a plurality by reason of the following. First, if a defect occurs to a light emitting diode substrate 50, the problem can be solved just by replacing the light emitting diode substrate 50 having the defect, thereby reducing a defect repairing cost. Second, if the size of the light emitting diode substrate 50 increases, it is difficult to mount the light emitting diode 60 on an entire of the light emitting diode substrate 50 to have a uniform property.

In an exemplary embodiment, each light emitting diode substrate 50 may be fixed to the lower cover 80, such as by using a screw (not shown).

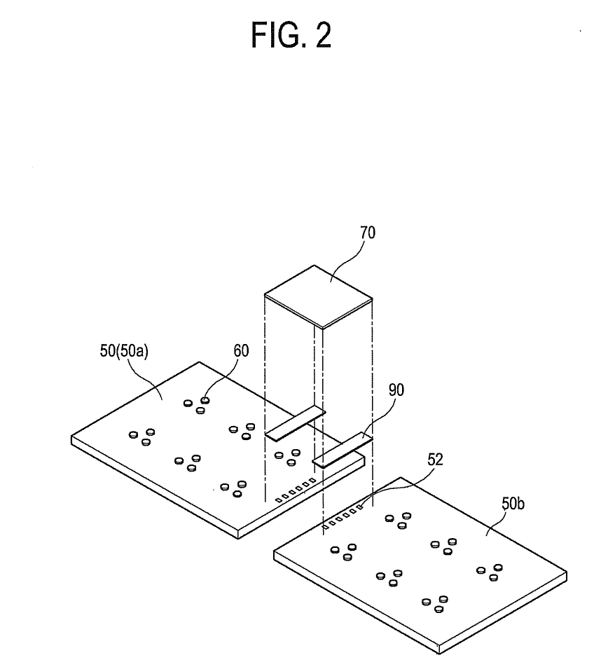

In each light emitting diode substrate 50, a plurality of light sources may be mounted. As in the illustrated embodiment, eighteen light emitting diodes 60 are arranged in a matrix form. Each light emitting diode substrate 50 of FIGS. 1 and 2 includes two columns by three rows of groups of light emitting diodes 60. The light emitting diodes are disposed in groups of three light emitting diodes 60.

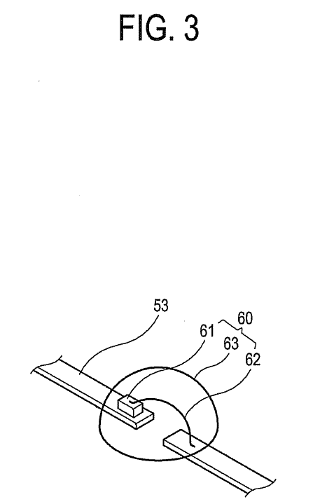

As in the exemplary embodiment shown in FIG. 3, the light emitting diode 60 may include a chip on board (“COB”). The light emitting diode 60 includes a chip 61, a wire 62 and a cover part 63.

The chip 61 of the light emitting diode 60 is connected to a first pair of power supplying lines 53. The chip 61 receives an electron and a hole from the first pair of power supplying lines 53 to generate light. In one exemplary embodiment, the chip 61 is directly mounted on one of the pair of power supplying lines 53.

The wire 62 of the light emitting diode 60 may be provided in a wire bonding type. The wire 62 connects the chip 61 and a second pair of power supplying lines 53. The cover part 63 protects the chip 61, and determines an emitting pattern of light generated from the chip 61. In one exemplary embodiment, the cover part 63 may be formed of a silicon resin or an acrylic resin.

If the light emitting diode 60 is provided by means of the COB, a packaging cost can be reduced, and a heat radiating property can be improved.

Alternatively, the light emitting diode 60 may be provided as a package type. A chip of the light emitting diode 60 may be mounted on a separate package, and the package including the chip may be mounted on the light emitting diode substrate 50.

The light emitting diode substrate 50 is electrically connected with adjacent light emitting diode substrates 50 through the connecting film 70.

As shown in FIGS. 2, 3 and 5, the light emitting diode substrate 50 includes a substrate main body 51, a pad part 52, and the power supplying line 53. The pad part 52 and the power supplying line 53 are formed on the substrate main body 51. Since the light emitting diode 60 generates a relatively large amount of heat, the substrate main body 51 may be formed of a main material with a relatively good thermal conductivity such as aluminum.

The pad part 52 of the light emitting diode substrate 50 may be disposed along a side and/or adjacent to an edge of the light emitting diode substrate 50. Referring to FIG. 2, in light emitting diode substrates 50a and 50b adjacent to each other, the pad parts 52 are respectively provided at sides of the adjacent light emitting diode substrates 50a and 50b facing each other. The pad parts 52 may be disposed in a single row along the side of the light emitting diode substrate 50, such as along a transverse side. Alternatively, the pad parts 52 may be disposed in multiple rows and/or along a longitudinal side of the light emitting diode substrate 50.

The pad parts 52 respectively provided to the adjacent light emitting diode substrates 50a and 50b are electrically connected through the connecting film 70. A width of the pad part 52 is larger than a width of the power supplying line 53 for connection with the connecting film 70. In an exemplary embodiment, the light emitting diode 60 may include three types emitting a red light, a green light and a blue light, each of the red, green and blue lights requiring a pair of power supplying lines injecting a hole and an electron to the lights, respectively.

Accordingly, the pad part 52 is disposed on the light emitting diode substrate 50 in a group of six. In alternative embodiments, the type of the light emitting diode 60 and/or the number of lines may be variously changed.

The connecting film 70 of the illustrated exemplary embodiment of FIGS. 1-5 includes a flexible printed circuit board (“FPCB”), and connects pairs of light emitting diode substrates 50, such as adjacent light emitting diode substrates 50.

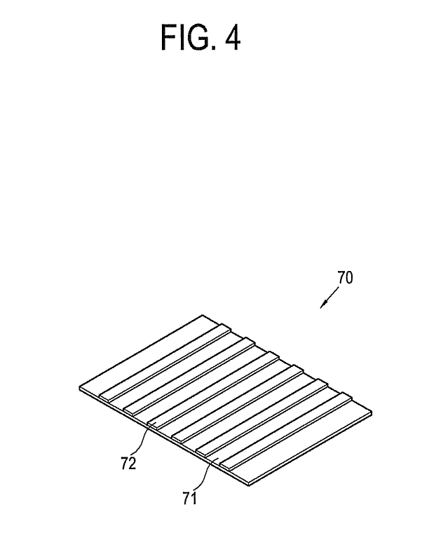

As shown in FIG. 4, the connecting film 70 includes a film main body 71 configured to be flexible, and a metal pattern 72 disposed on the film main body 71. The film main body 71 may be formed of a plastic material. As in the illustrated embodiment, six metal patterns 72 may be disposed on the film main body 71 of the connecting film 70, such as a same number of the pad part 52 on the LED substrate 50.

The metal pattern 72 is elongated along a surface of the connecting film 70, such as along a transverse direction of the connecting film 70. The metal patterns 72 may be disposed parallel to one another. In one exemplary embodiment, the metal patterns 72 may include copper.

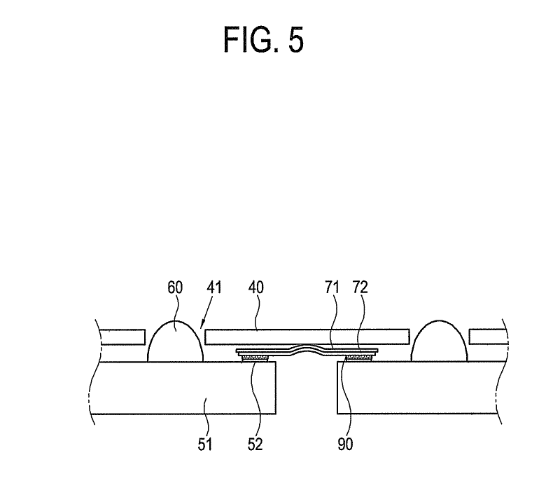

Hereinafter, an exemplary embodiment of a connection between the light emitting diode substrates 50 using the connecting film 70 according to the present invention will be described by referring to FIG. 5.

As shown in FIG. 5, opposing end portions of the metal pattern 72 of the connecting film 70 connect the pad part 52 of adjacent light emitting diode substrates 50. An anisotropic conductive film 90 is disposed between the metal pattern 72 at ends of the connecting film 70 and the pad part 52 disposed on the light emitting diode substrate 50. The anisotropic conductive film 90 may include a continuous resin part, and a conductive member, such as a ball, ejected into the resin part. The resin part couples the connecting film 70 and the light emitting diode substrate 50, and the conductive ball electrically connects the pad part 52 and the metal pattern 72.

In an exemplary embodiment of a manufacturing process of a liquid crystal display, the anisotropic conductive film 90 may be disposed along a longitudinal direction of the pad part 52. Then, the connecting film 70 is arranged on the anisotropic conductive film 90, and a pressure is applied to the connecting film 70 and the light emitting diode substrate 50. After applying the pressure to the connecting films 70 and the light emitting diode substrate 50, if the resin part is cured, the connection is completed. In the applying the pressure, the conductive balls in the anisotropic conductive film 90 are contacted with each other to electrically connect the pad part 52 and the metal pattern 72.

Hereinafter, a relation between the reflecting sheet 40 and the connecting film 70 will be described with reference to FIGS. 1 and 5.

The reflecting sheet 40 reflects light generated from the light emitting diode 60 to be supplied to the diffusing plate 31. If a surface of the reflecting sheet 40 is not flat, light is irregularly supplied to the diffusing plate 31 and may deteriorate a display quality of the liquid crystal display. The reflecting sheet 40 may be fixedly attached to the light emitting diode substrate 50 to be stably disposed.

As shown in FIG. 5, a portion of an upper surface of the light emitting diode substrate 50 adjacent to the light emitting diode 60 is substantially flat. Accordingly, the reflecting sheet 40 correspondingly positioned adjacent to the light emitting diode substrate 50 proximate the light emitting diode 60 in a substantially planar manner.

The light emitting diode 60 is disposed in the through hole 41 of the reflecting sheet 40 and may protrude from an upper surface of the reflecting sheet 40. The through hole 41 of the reflecting sheet 40 may correspond to the light emitting diode 60 substantially in shape and/or dimension, such that the light emitting diode 60 is accommodated in the through hole. In an exemplary embodiment, a planar shape of the light emitting diode may be substantially circular and a shape of the through hole 41 may be substantially rectilinear.

At a portion of the light emitting diode substrate 50 to which the pad part 52 is positioned, the connecting film 70 is separated from the upper surface of the light emitting diode substrate 50 by an interval. In the illustrated embodiment, a thickness of the connecting film 70 is relatively very small in comparison with a thickness of a conventional connector. A total thickness of the connecting film 70 and the anisotropic conductive film 90 of the illustrated embodiment is also relatively very small in comparison with the thickness of the conventional connector. Advantageously, since the connecting film 70 has flexibility, deformation is allowed unlike the conventional connector.

The connecting film 70 is contacted against the reflecting sheet 40, e.g., against a lower surface of the reflecting sheet 40. A portion of the connecting film 70 contacting against the reflecting sheet 40 is deformed so that the reflecting sheet 40 can be disposed substantially planar. In an exemplary embodiment, the connecting film 70 may include a raised or protruding portion that contacts the lower surface of the reflecting sheet 40. As illustrated in FIG. 5, the raised portion may be a bent portion of the connecting film 70, such a disposed in a central part of the connecting film 70. The film main body 71 and/or the metal pattern 72 may include the raised portion, such as in corresponding profiles.

Advantageously, the reflecting sheet 40 can be flatly disposed over substantially an entire of the reflecting sheet, thereby improving a display quality of the liquid crystal display. Also, if a problem occurs in a connection of the connecting film 70 and the light emitting diode substrate 50, the connecting film 70 may be removed, such as by heating, and a replacement connecting film 70 may be connected thereto, thereby conveniently completing repair.

In an exemplary embodiment, the backlight unit 2 may further include a heat pipe (not shown), a radiating fin (not shown), a cooling fan (not shown), etc. to facilitate heat radiation. Also, a gap pad (not shown) may be provided between the light emitting diode substrate 50 and the lower cover 80 to reduce or effectively prevent an air layer from being formed between the light emitting diode substrate 50 and the lower cover 80.

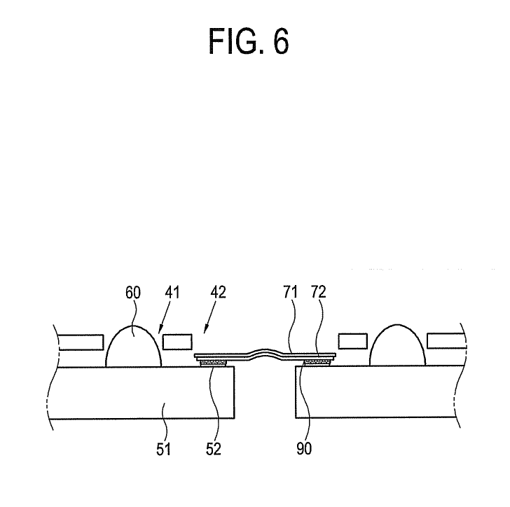

Hereinafter, another exemplary embodiment of a liquid crystal display device according to the present invention will be described by referring to FIG. 6.

As shown in FIG. 6, a second through hole 42 is formed in a reflecting sheet 40 to expose a connecting film 70. According to the illustrated exemplary embodiment of the present invention, a planar form, e.g. the flatness of the reflecting sheet 40, can be further improved. A surface (e.g., upper surface) of the connecting film 70 exposed through the through hole 42 may be laminated, and/or include a reflecting particle (not shown) to improve reflection of light. Alternatively, other reflecting films may be attached on the exposed connecting film 70.

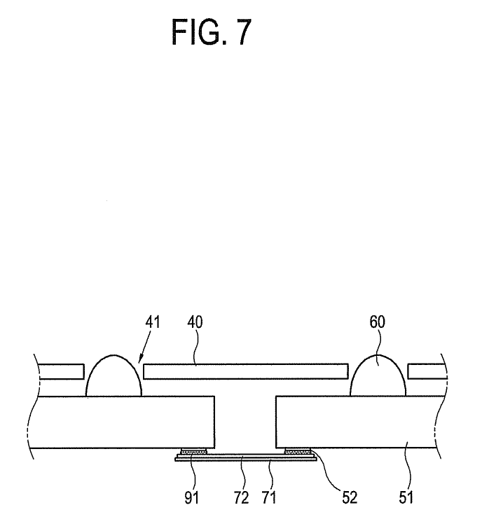

Hereinafter, another exemplary embodiment of a liquid crystal display device according to the present invention will be described by referring to FIG. 7.

As shown in FIG. 7, a light emitting diode 60 and a pad part 52 are provided to opposing surfaces of a substrate main body 51 of the light emitting diode substrate 50. That is, the pad part 52 may be disposed on a surface of the light emitting diode substrate 50 positioned towards a lower cover 80, e.g., a surface opposing the surface upon which the light emitting diode 60 is disposed. A connecting film 70 may be disposed to face the lower cover 80.

In an exemplary embodiment, the pad part 52 is electrically connected with the light emitting diode 60 through a via (not shown) formed to the substrate main body 51.

According to the illustrated exemplary embodiment of the present invention, flatness of the reflecting sheet 40 can be further improved. Advantageously, since a through hole exposing the connecting film 70 is not provided, uniformity of reflection can be further improved.

In the illustrated exemplary embodiment, a film main body 71 may be formed of acryl glass, such as FR4. A metal pattern 72 and the pad part 52 may be connected through connecting member 91, such as a solder. If the light emitting diode 60 and the pad part 52 are formed on a same surface of the substrate main body 51, the connecting film 70 including the film main body 70 formed of the acryl glass may be used.

In an exemplary embodiment, connection between a light emitting diode substrate 50 and the connecting film 70 through the solder 91 may be automated by using a surface mount technology.

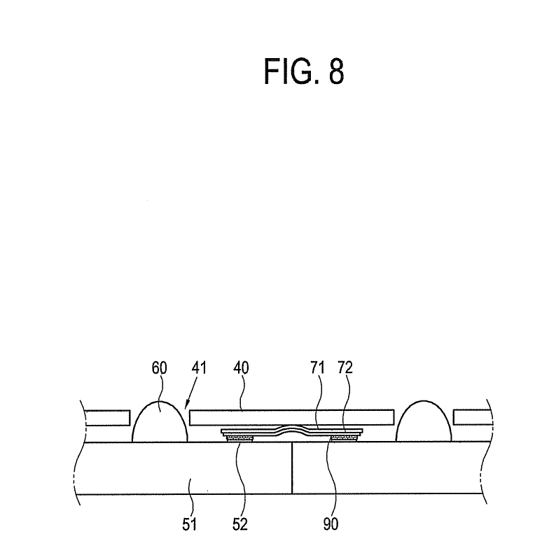

Hereinafter, another exemplary embodiment of a liquid crystal display device according to the present invention will be described by referring to FIG. 8.

As shown in FIG. 8, substrate main bodies 51 are forcedly contacted each other, e.g., facing sides of adjacent substrate main bodies 51 directly contact each other. Accordingly, an arrangement of light emitting diodes 60 becomes uniform across a collective upper surface of a plurality of light emitting diode substrates 50, and light having a substantially uniform brightness can be supplied to the liquid crystal display.

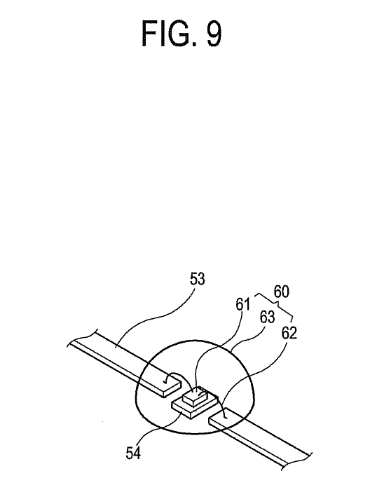

Hereinafter, another exemplary embodiment of a liquid crystal display device according to a fifth exemplary embodiment of the present invention will be described by referring to FIG. 9.

As shown in FIG. 9, a chip 61 is mounted to a chip seating part 54 disposed on a substrate main body 51 of the light emitting diode substrate 50. In an exemplary embodiment, the chip 61 may be mounted to the substrate main body 51 using a soldering process. Advantageously, the chip seating part 54 simplifies the soldering. The chip seating part 54 and a power supplying line 53 may be formed of the same materials.

As in the illustrated embodiment, the light emitting diode 60 may include a pair of the wires 62. One of the wires 62 is connected from the chip 61 to a first power supplying line 53 and the other of the pair of wires 62 is connected from the chip 61 to a second power supplying line 53. The chip, wires 62 and chip seating part 54 are enclosed in and surrounded by the cover 63.

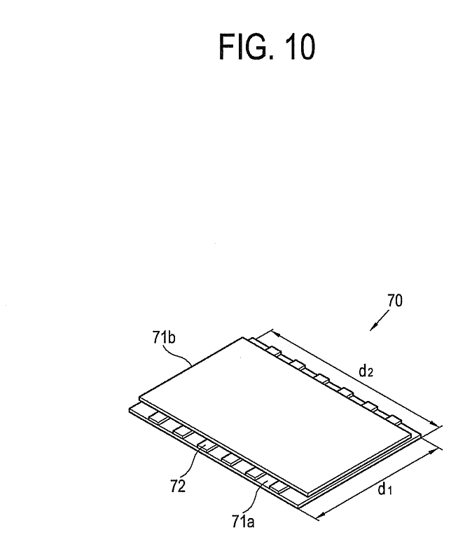

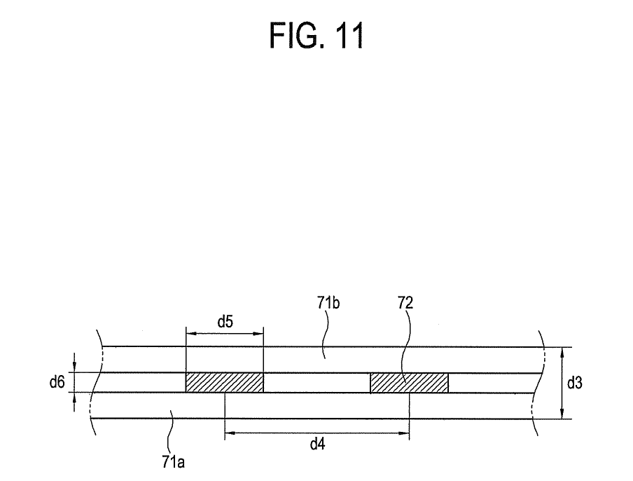

Hereinafter, another exemplary embodiment of a liquid crystal display device according to the present invention will be described by referring to FIGS. 10 and 11. FIGS. 10 and 11, illustrate a connecting film 70. The connecting film 70 of the illustrated exemplary embodiment connects a light emitting diode substrate 50 in a substantially similar manner to the exemplary embodiments of FIGS. 1-9.

The connecting film 70 of FIGS. 10 and 11 includes a flexible flat cable (“FFC”). The connecting film 70 includes a metal pattern 72, and a first film main body 71a and a second film main body 71b disposed at opposing sides of the metal pattern 72. The second film main body 71b has a smaller area than the first film main body 71a. When the second film main body 71b is arranged on the first film main body 71a, opposing end portions of the metal pattern 72 are exposed. The exposed opposing end parts of the metal pattern 72 are respectively connected to pad parts 52 of different, e.g., adjacent, light emitting diode substrates 50.

A length d1 and a width d2 of the connecting film 70 may be respectively about 5 μm and about 15 μm. A total thickness d3 of the connecting film 70 may be about 0.2 μm to about 0.5 μm. A distance d4 between centers of the metal pattern 72 taken substantially parallel to a longitudinal direction of the connecting film 70 may be about 0.5 μm to 2 μm.

The distance d4, a width d5 and a thickness d6 of the metal pattern 72 is determined according to a voltage applied to the metal pattern 72.

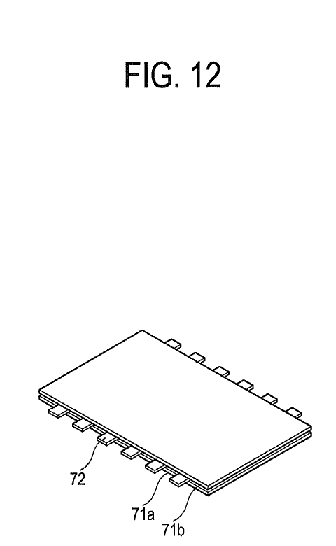

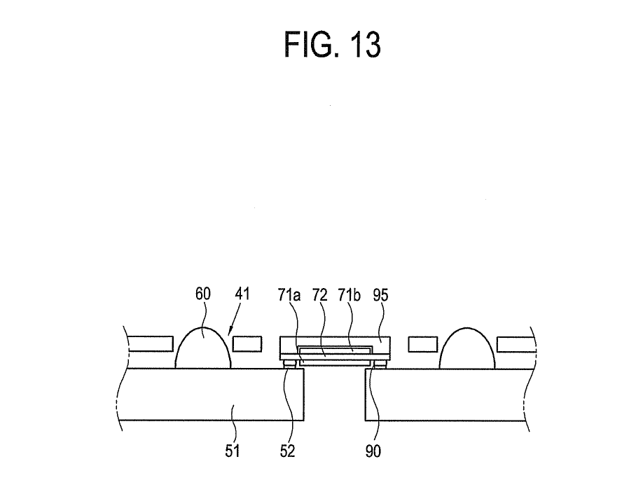

Hereinafter, an exemplary embodiment of a liquid crystal display device according to the present invention will be described by referring to FIGS. 12 and 13.

As shown in FIG. 12, a first film main body 71a and a second film main body 71b have substantially the same sizes, e.g., areas. Opposing end portions of a metal pattern 72 are exposed to an outside of the first and second film main bodies 71a and 71b.

As shown in FIG. 13, the exposed opposing end portions of the metal pattern 72 are respectively connected to pad parts 52 of different, e.g., adjacent, light emitting diode substrates 50. The metal pattern 72 exposed to the outside of the first and second main film bodies 71a and 71b is covered by a film cover 95. In an exemplary embodiment, the film cover 95 may be formed of an insulating material. The film cover 95 is disposed on the exposed ends of the metal pattern 72 and surround the second main film body 71b.

Advantageously, since the connecting film 70 is relatively thin, a light loss and a color mixing deterioration, can be reduced or effectively prevented. Also, since the connecting film 70 is relatively cheap, cost can be reduced although the light emitting diode substrate 50 is miniaturized requiring a plurality of connecting films 70 between the light emitting diode substrates 50.

In the exemplary embodiments described above, the backlight assembly of a direct type is exemplarily described. However, the present invention can be applied to a backlight assembly of a side type in which a light source is positioned to a side of a liquid crystal display panel.

As in the illustrated exemplary embodiments, the present invention provides a backlight assembly and a liquid crystal display device including the same electrically connecting a plurality of point light source substrates in a relatively simple configuration.

As in the illustrated exemplary embodiments, a manufacturing method of a backlight assembly electrically connecting a plurality of point light source substrates is simplified.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A backlight assembly, comprising:
a plurality of point light source substrates, each of the point light source substrates comprising:
a substrate main body,
a power supplying line disposed on the substrate main body, and
a pad part disposed on the substrate main body and electrically connected to the power supplying line;
a point light source disposed on each of the point light source substrates, and supplied with power through the power supplying line; and
a connecting film connecting adjacent point light source substrates and comprising:
a first film main body, and
a metal pattern disposed on the first film main body and electrically connected with the pad part of the adjacent point light source substrates.

2. The backlight assembly according to claim 1, wherein the point light source comprises a light emitting diode.

3. The backlight assembly according to claim 2, wherein the point light source comprises a chip, and the chip is mounted to the point light source substrates as a chip on board (“COB”) type.

4. The backlight assembly according to claim 1, wherein the metal pattern includes a plurality of metal patterns disposed parallel with each other.

5. The backlight assembly according to claim 4, wherein the metal pattern comprises copper.

6. The backlight assembly according to claim 1, wherein the first film main body of the connecting film comprises a plastic material, and the connecting film is configured to be flexible.

7. The backlight assembly according to claim 6, further comprising a reflecting sheet comprising a through hole exposing the point light source, the reflecting sheet being disposed over the point light source substrates,
wherein the connecting film contacts the reflecting sheet.

8. The backlight assembly according to claim 6, wherein the connecting film further comprises a second film main body, and
the metal pattern is disposed between the first film main body and the second film main body.

9. The backlight assembly according to claim 8, wherein end portion of the metal pattern are exposed out of at least one of the first film main body and the second film main body.

10. The backlight assembly according to claim 1, wherein the first film main body comprises acryl glass.

11. The backlight assembly according to claim 1, further comprising an anisotropic conductive film disposed between the metal pattern and the pad part.

12. The backlight assembly according to claim 1, further comprising a solder disposed between the metal pattern and the pad part.

13. The backlight assembly according to claim 1, wherein the pad part and the point light source are disposed on same surfaces of the point light source substrates.

14. The backlight assembly according to claim 1, further comprising a reflecting sheet comprising a through hole exposing the point light source, the reflecting sheet being disposed over the point light source substrates,
wherein the reflecting sheet covers the connecting film.

15. The backlight assembly according to claim 1, further comprising a reflecting sheet comprising a through hole exposing the point light source and the connecting film, the reflecting sheet being disposed over the point light source substrates,
wherein an exposed surface of the connecting film comprises a reflecting particle.

16. The backlight assembly according to claim 1, wherein the pad part and the point light source are disposed on opposing sides of the point light source substrates.

17. The backlight assembly according to claim 1, wherein the point light source substrates are arranged in a matrix shape.

18. A manufacturing method of a backlight assembly, the method comprising:
providing a first point light source substrate and a second point light source substrate, each of the first and second point light source substrates comprising a substrate main body and a pad part formed on the substrate main body;
providing a connecting film comprising a film main body and a metal pattern formed on the film main body;
mounting a point light source to each point light source substrate, the point light source configured to be supplied with power through the pad part; and
connecting a first end portion of the metal pattern to the pad part of the first point light source substrate, and connecting a second end portion of the metal pattern to the pad part of the second point light source substrate, the first end portion being opposite to the second end portion.

19. A liquid crystal display device comprising:
a liquid crystal display panel, and
a backlight assembly disposed in a rear of the liquid crystal display panel and configured to supply light to the liquid crystal display panel, the backlight assembly comprising a plurality of point light source substrates, each of the point light source substrates comprising:
a substrate main body,
a power supplying line disposed on the substrate main body, and
a pad part disposed on the substrate main body and electrically connected to the power supplying line;
a point light source disposed on each of the point light source substrates, and supplied with power through the power supplying line; and
a connecting film comprising:
a first film main body, and
a metal pattern disposed on the first film main body and electrically connected with the pad part of the light emitting diode substrate, the connecting film connecting adjacent point light source substrates.

20. The liquid crystal display device according to claim 19, wherein the point light source comprises a light emitting diode.

21. The liquid crystal display device according to claim 19, wherein the point light source comprises a plurality of groups of light emitting diodes.

22. The liquid crystal display device according to claim 19, wherein the point light source comprises a chip, and the chip is mounted to the point light source substrates as a chip on board (“COB”) type.

23. The liquid crystal display device according to claim 19, wherein the metal pattern includes a plurality of metal patterns extending parallel with each other.

24. The liquid crystal display device according to claim 23, wherein the metal pattern comprises copper.

25. The liquid crystal display device according to claim 19, wherein the first film main body of the connecting film comprises a plastic material, and the connecting film is flexible.

26. The liquid crystal display device according to claim 25, wherein the connecting film further comprises a second film main body, and
the metal pattern is disposed between the first film main body and the second film main body.

27. The liquid crystal display device according to claim 26, wherein an end portion of the metal pattern is exposed out of at least one of the first film main body and the second film main body of the connecting film.

28. The liquid crystal display device according to claim 26, wherein opposing ends of the metal pattern are exposed out of both the first film main body and the second film main body.

29. The liquid crystal display device according to claim 19, wherein the first film main body comprises acryl glass.

30. The liquid crystal display device according to claim 19, further comprising a solder disposed between the metal pattern and the pad part of the point light source substrates.
